(19) United States
(12) Patent Application Publication
(10) Pub. No.: US 2007/0084321 A1
(43) Pub. Date: Apr. 19, 2007

(54) Method and apparatus for rapid cooling of baked goods

(76) Inventors: Michel Ciambella, Barrie (CA); Van Miller, Norval (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 11/163,288

(22) Filed: Oct. 13, 2005

(51) Int. Cl. B26D 1/00; B27B 11/00

(52) U.S. Cl. 83/13; 83/761; 83/454

(57) ABSTRACT

A method and apparatus for cooling sliced bread before wrapping. First, the bread product is sliced into at least two slices, each corresponding pair of slices having opposed slice surfaces. Next, at least one portion of the surfaces are separated away from the corresponding opposed slice surface. Finally, at least one of said slice surfaces is cooled. The cooling may occur by expelling cooling fluids proximate said at least one portion of said slice surface. The cooling fluid may be compressed air. The compressed air may be filtered and/or sterilized (e.g. by means of a sterilization agent). Optionally, the slices are completely separated from one another.

### FIELD OF THE INVENTION

This invention relates to a method and apparatus for preparing baked goods for wrapping, and particularly to a method and apparatus for rapidly reducing the temperature of baked goods after baking to a temperature conducive to wrapping.

### BACKGROUND OF THE INVENTION

Since the dawn of commercial baking of baked goods (such as loaves of bread, rolls etc.), it has always been a challenge to reduce the temperature of the baked goods after baking to a temperature suitable for wrapping. If the temperature is too high, condensation of free water will occur on the inner surface of the packaging material or on the outer surface of the baked goods.

After removal from a commercial oven, baked goods normally have a temperature of around 92 to 97 degrees Celsius. Prior to wrapping, it is preferable to have a temperature of at most 35 degrees Celsius in order to prevent the condensation discussed above. In addition, baked goods wrapped at higher temperatures are more likely to suffer from contamination problems such as mould. As well, baked goods wrapped at higher temperatures will have a softer texture and will not stack as well in the retail environment. The softer texture also make the loaves more difficult to stack. In addition, baked goods wrapped at higher temperatures are more susceptible to suffer from problems such as mould growth. As well, baked goods wrapped at higher temperatures will have a softer texture and will not stack as well in the retail environment.

A number of means have been used to deal with this problem in the commercial bakery setting. In order to reduce the temperature as quickly as required, commercial bakeries have introduced large cooling rooms equipped with massive heat exchangers, fans and other cooling equipment. This method has proven somewhat useful for traditional sliced bread as the amount of energy required has not been prohibitive. However, newer breads, such as the Country Harvest™ brand breads from George Weston Limited, are denser than traditional breads due to the presence of whole grains. Traditional cooling rooms are not up to the task of bringing down the temperature to acceptable levels within acceptable amounts of time. In addition, in some areas, the ambient temperature is often around 40 degrees Celcius which makes it difficult to obtain sufficient cooling. Given that commercial bakeries will often produce bread at the rate of 2000 to 20000 loaves per hour, it is imperative for the sake of operational efficiency to ensure that the temperature reduction occurs within a reasonable time frame (approximately 40 to 60 minutes).

Another method for dealing with the problem of adequate temperature removal is to make the packaging for the baked goods breathable. However, this solution risks the introduction of contaminants and is not conducive to a long shelf life.

U.S. Pat. No. 5,472,724 issued on Dec. 5, 1995 to Interstate Brands Company-Licensing Co. describes yet another method for obtaining this temperature reduction. This patent teaches that baked goods, on removal from an oven, may travel on a conveyor belt through a freezer that is cryogenically chilled. The temperature of the baked goods was reduced to a around negative 5 degrees Celsius in the freezer and then allowed to return on packaging to room temperature.

The difficulty with the '724 patent is that the temperature reduction of the bread to below freezing and then allowing the bread to return to ambient conditions presents problems. First, the energy expenditure and the cost of cryogenic gases for a cryogenic freezer in commercial bakeries is enormous. The ratio of the surface area of the bread (outer surface areas as well as inner surface area) to the mass of the bread is very high. As the cryogenic cooling is applied from the outside to the inside of the bread, the outer surface of the bread is cooled an excessive amount in order to obtain the desired internal temperature. This results in inefficient cooling.

What is desired is a method for reducing the temperature of baked goods for packaging and sale that does not require massive expenditures of energy. The desired method should ideally allow the baked goods to be maintained in a desirable condition.

### SUMMARY OF THE INVENTION

In keeping with the present invention, disclosed herein is a method for cooling a bread product. First, the bread product is sliced into at least two slices, each corresponding pair of slices having opposed slice surfaces. Next, at least one portion of the surfaces are separated away from the corresponding opposed slice surface. Finally, at least one of said slice surfaces is cooled.

The cooling may occur by expelling cooling fluids proximate said at least one portion of said slice surface. The cooling fluid may be compressed air. The compressed air may be filtered and/or sterilized (e.g. by means of a sterilization agent).

Optionally, the slices are completely separated from one another.

Optionally, the cooling may occur by passing said at least one slice proximate to a refrigerated surface.

The bread product may have a defined loaf shape, and the method further comprises the step of arranging the slices so as to substantially reform that defined loaf shape.

Subsequent to the cooling, the sliced bread may then be packaged.

Further in keeping with the disclosed invention is an apparatus for imparting additional cooling to a bread product. The bread product is sliced along slice lines and having inner sliced surfaces. The apparatus has at least one separation means positioned proximate said slice lines. The separation means acts to separate at least a portion of the bread slices from one another. At least one cooling means is positioned along the slice lines and cools the inner sliced surfaces of said bread product.

The cooling means may be vents in fluid communication with a source of cooling fluid. The vents may be controllable to expel cooling fluid along the bread slices. The cooling fluid may be compressed air, which may be filtered and/or sterilized (e.g. with a sterilization agent). Alternatively, the cooling fluid may be a cryogenic fluid.

The separation means may act to completely separate the slices from one another.

Alternatively, the cooling means are refrigerated surfaces.

The separation means may optionally include slice tracks having slice guides.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is an end view of a first embodiment of an apparatus in keeping with the present invention;

FIG. 2 is an end view of a second embodiment of an apparatus in keeping with the present invention;

FIG. 3 is a top plan view of the embodiment shown in FIG. 2;

FIG. 4 is a top plan view of a third embodiment of an apparatus in keeping with the present invention;

FIG. 5 is a sectional view of the apparatus of FIG. 4 taken along lines 5-5; and

FIG. 6 is a sectional view of the apparatus of FIG. 4 taken along lines 6-6.

### DETAILED DESCRIPTION OF THE PREFERRED EMBODIMENTS

Baked products that are to be sliced are prepared in a variety of manners. Typically, dough is mixed and then baked in an oven. The baked loaf is then cooled in a cooling room or cooling tunnel and then sliced. After slicing, the loaf is then bagged and sent for sale.

In the present method, the amount of time required for the initial cooling is reduced significantly and then subjected to an additional cooling step after the loaf is sliced.

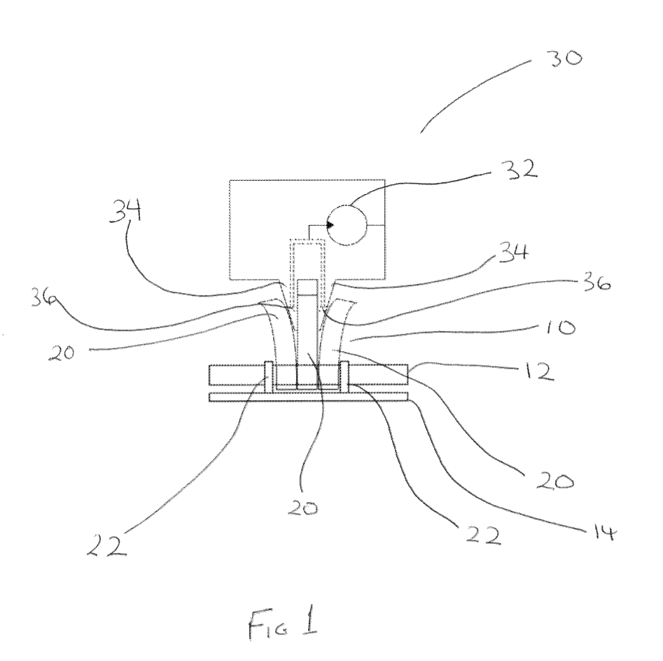

FIG. 1 shows a first embodiment of a method and apparatus of providing the additional cooling step after slicing. Loaf 10 is directed through the bread preparation process in a track direction A by a rod 12 on a track 14. Loaf 10 is shown here as having three slices for the sake of simplicity. Obviously, most loaves of bread are sliced into many more slices. Each slice line forms a corresponding pair of slices with inward facing opposed surfaces. The details of the operation of rod 12 and track 14 are known in the art and are not described in any detail.

After baking and passing through the initial cooling stage, loaf 10 is directed through a slicer which slices the loaf into slices 20 in the transverse direction. After passing through the slicer, slices 20 are kept together by the side rails 22 of track 14. Side rails 22 are preferably around one third to one half the height of loaf 10. The height of the side rails serves to keep the bottom portions of slices 20 together while allowing relative movement of the upper portion of slices 20 in the lateral direction.

Loaf 10 then passes through an air injection unit 30. A cooling means in the nature of air injection unit 30 includes a common source of pressurized cooling fluid in the form of a pump 32 and separation means in the nature of a row of wedged vent chambers 34. Wedged vent chambers 34 are positioned such that they cause the upper portion of slices 20 to separate from one another, while the lower portion of slices 20 are kept together by side rails 22. As loaf 10 passed through air injection unit 30, the pressurized cooling fluid is expelled from at least one outlet 36 in each of vent chambers 34. As the pressurized cooling fluid leaves vent chambers 34 and strikes the sides of slices 20, the bread undergoes significant and rapid cooling.

After loaf 10 passes through air injection unit 30, the temperature of the bread has fallen to a level low enough to be wrapped without significant condensation.

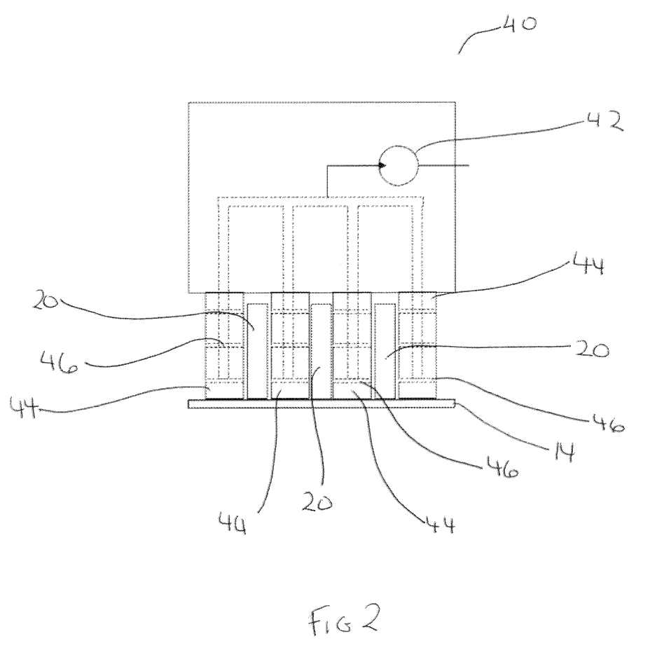

A second embodiment of the apparatus of the present invention is shown at FIGS. 2 and 3. This apparatus is another air injection unit 40 having a common source of compressed air in the form of a pump 42, vent chambers 44 having air outlets 46, and slice guide separators 48 and slice guide assemblers 50. In this embodiment, slice guide separators 48 are wedge-shaped and extend downwardly to track 14 and act to completely separate slices 20 from one another as slices proceed along the track from position L1 through position L2 and into position L3. Slices 20 individually pass though vent chambers 44 and a cooling fluid is expelled at one or more points by air outlets 46 onto sides of slices 20 again resulting in significant cooling.

After the slices pass vent chambers 44, they are directed by slice guide assemblers 50 back into a unitary loaf 10 (showing at position L3). Loaf 10 is then ready for wrapping.

Preferably, the distance between each of vent chambers 44 is slightly greater than the thickness of a single slice. This would allow slice 20 to flutter slightly between vent chambers 44 as it is struck by the cooling fluid.

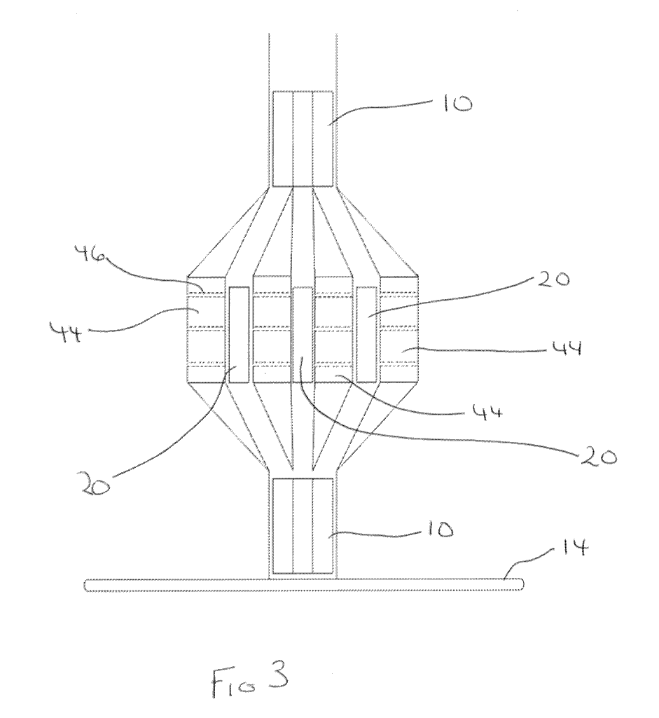

In another embodiment in accordance with the present invention, a means for separating the slices is shown in FIGS. 4 to 6. This embodiment is similar to that shown in FIGS. 2 and 3, except that the separation of the slices occurs by means of a guide track and the cooling fluid originates from below the track (not shown).

FIG. 4 is a top view of a track 60 having defined slice paths 62 defined by slice rails 64. A loaf 10, after being cut into slices 20 is propelled along track 60 (according to means known in the art) from the bottom of FIG. 4 to the top of FIG. 4. Loaf 10 at position L4 is still substantially unitary in that the slices 20 are not substantially separated from one another. Slice paths 62 diverge from one another in a first zone 70 as slices 20 are separated. In a second zone 72, slice paths 62 are parallel. Slice paths 62 then converge in a third zone 74.

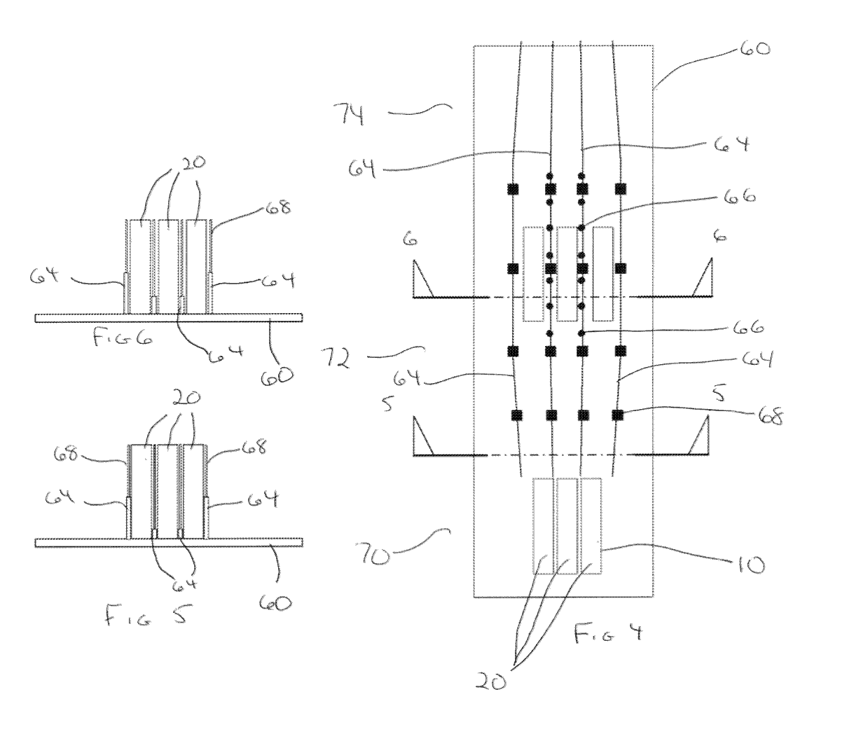

In the first zone, slice rails 64 increase in height (as shown in the difference in height in FIGS. 5 and 6). This increase in height assists the placement of slices 20 into the slice paths. In the second zone 72, the height of slice rails 64 stays constant. In the third zone 74, the height of slice rails 64 is reduced to facilitate the reunification of slices 20 into a loaf 10.

FIG. 4 shows the location of vents 66 in slice rails 64. Vents 66 are integrated with slice rails 64. Vents 66 are in fluid communication with the underside of track 60 and are connected to a source of cooling fluid (not shown). As slices 20 pass through the slice paths in the second zone 72, a cooling fluid is expelled through vents 66 between slices 20 to cool the bread.

FIG. 4 also shows a series of guide posts 68. Guide posts 68 extend upwardly from slice rails 64 for the whole height of the slices of bread. Guide posts 68 are spaced apart of each slice rail 64 by approximately the length of slice 20. Guide posts 68 act to maintain the upper portion of slices 20 in the individual slice tracks 62.

The length of second zone 72 is dictated by the desired dwell time of the slices. It has been found that a dwell time of approximately five seconds can reduce the temperature of a loaf of bread by approximately 10 degrees Celsius. A number of factors come into play in determining the dwell time, including the amount of cooling desired, the method of cooling etc.

Preferably, the cooling fluid has been filtered and/or sterilized to prevent the introduction of contaminants into the bread. The cooling fluid may be a pressurized gas (such as ambient air). The cooling fluid may be treated with a sterilization or shelf-life extending agent such as an ethyl alcohol mist to inhibit the introduction of contaminants. The cooling fluid may also be a cryogenic fluid to cause the bread to freeze in an even manner.

In an optional alternative to the present embodiments, instead of the bread passing through the air injection unit where the slices are separated by means of the forward motion of the bread abutting various guide means, the air injection unit may be lowered onto the loaf using wedged vent chambers or other means known in the art to separate the portions of the bread slices to be separated.

In another alternative, the compressed air outlets may each be individually controlled to maximize fluttering of the slice of bread. For example, the slice may be subjected to alternating blasts of pressurized cooling fluid on either side. This would maximize fluttering and promote rapid cooling.

In still another alternative embodiment, the inter-slice cooling means may include refrigerated plates. Such an embodiment could closely resemble the embodiment shown in FIG. 2, except that the vent chambers 44 would be replaced by refrigerated plates. The slice surfaces could come into contact or close proximity with the refrigerated plates and undergo cooling in that manner.

In another variation of the present invention, a slicer could be incorporated into the slice separation means. Slicers at present act to form the slices and perform a minor separation of the slices. An integrated slicer would reduce the space required in an assembly line.

The above method may be used with any sliced bread product, such as slices rolls, bagels, etc.

The above method may also be implemented at any time after the bread is sliced.

The novel features which are believed to be characteristic of the present invention, as to its structure, organization, use and method of operation, together with further objectives and advantages thereof, will be better understood from the following discussion.

Other modifications and alterations may be used in the design and manufacture of the apparatus and methods of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially the same height is intended to mean of the same height, nearly the same height, and/or exhibiting characteristics associated with being of a particular elevation above a reference elevation.

What is claimed is:

1. A method for cooling a bread product comprising the steps of:
(a) slicing the bread product into at least two slices, each corresponding pair of slices having opposed slice surfaces;
(b) separating at least one portion of said slice surfaces away from the corresponding opposed slice surface; and
(c) cooling at least one of said slice surfaces.

2. A method as claimed in claim 1, wherein said cooling occurs by expelling cooling fluids proximate said at least one portion of said slice surface.

3. A method as claimed in claim 1, wherein said slices are completely separated from one another.

4. A method as claimed in claim 2, wherein said cooling fluid is compressed air.

5. A method as claimed in claim 4, wherein said compressed air is filtered.

6. A method as claimed in claim 4, wherein said compressed air is sterilized.

7. A method as claimed in claim 6, wherein said compressed air includes a sterilization agent.

8. A method as claimed in claim 1, wherein said cooling occurs by passing said at least one slice proximate to a refrigerated surface.

9. A method as claimed in claim 1, wherein said bread product has a defined loaf shape, and further comprising the step of arranging said slices so as to substantially reform said defined loaf shape.

10. A method as claimed in claim 9, further comprising the step of packaging said bread product.

11. An apparatus for imparting additional cooling to a bread product, the bread product being sliced along slice lines and having inner sliced surfaces, the apparatus comprising:
(a) at least one separation means positioned proximate said slice lines, said separation means acting to separate at least a portion of the bread slices from one another; and
(b) at least one cooling means positioned along said slice lines, said cooling means acting to cool the inner sliced surfaces of said bread product.

12. An apparatus as claimed in claim 11, wherein said cooling means are vents in fluid communication with a source of cooling fluid, said vents being controllable to expel cooling fluid along said bread slices.

13. An apparatus as claimed in claim 11, wherein said cooling means are refrigerated surfaces.

14. An apparatus as claimed in claim 11, wherein said separation means acts to completely separate said slices from one another.

15. An apparatus as claimed in claim 12, wherein said cooling fluid is compressed air.

16. An apparatus as claimed in claim 15, wherein said compressed air is filtered.

17. An apparatus as claimed in claim 15, wherein said compressed air is sterilized.

18. An apparatus as claimed in claim 15, wherein said compressed air includes a sterilization agent.

19. An apparatus as claimed in claim 12, wherein said cooling fluid is a cryogenic fluid.

20. An apparatus as claimed in claim 11, wherein said separation means comprises slice tracks having slice guides.
